(19) United States
(12) Patent Application Publication
(10) Pub. No.: US 2010/0173803 A1
(43) Pub. Date: Jul. 8, 2010

(54) INK JET DEVICE FOR PRODUCING A BIOLOGICAL ASSAY SUBSTRATE BY RELEASING A PLURALITY OF SUBSTANCES ONTO THE SUBSTRATE, AND METHOD FOR MONITORING THE INK JET DEVICE

(75) Inventors: Anke Pierik, Eindhoven (NL); Johan Frederik Dijksman, Eindhoven (NL); Martin Maurice Vernhout, Eindhoven (NL); Leonardus Johannes Cornelius Van Den Besselaar, Eindhoven (NL); Dirkjan Bernhard Van Dam, Eindhoven (NL); Giovanni Nisato, Eindhoven (NL); Albert Hendrik Jan Immink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/377,174

(22) PCT Filed: Aug. 10, 2007
(86) PCT No.: PCT/IB07/53181

§ 371 Date: Feb. 11, 2009

(30) Foreign Application Priority Data
Aug. 15, 2006 (EP) 06118915.5

(51) Int. Cl. C40B 50/14; C40B 60/14; G06F 17/00

(52) U.S. Cl. 506/30; 506/40; 235/375

(57) ABSTRACT

The invention provides an ink jet device and method for producing a biological assay substrate (41) by releasing a plurality of substances onto the substrate (41) The device comprises at least a print head and a plurality of substance containers (60, 61, 62) connectable thereto, and mounting means (55) for the containers, whereby at least part of the containers (60, 61, 62) is provided with identification means (63) The device further comprises reading means to read information contained in the identification means (63).

### FIELD OF THE INVENTION

The present invention relates to an ink jet device for producing a biological assay substrate by depositing a plurality of substances onto the substrate. The present invention further relates to a method for producing such biological assay substrate and to the use of an ink jet device thereto.

### BACKGROUND OF THE INVENTION

The present invention discloses an ink jet device for producing a biological assay substrate by depositing a plurality of substances onto a substrate, a method and the use of an ink jet device. Especially for diagnostics, substrates are needed where a plurality of preferably different substances are positioned in a very precise and accurate manner. This plurality of substances are usually to be positioned on a substrate in order to perform a multitude of biochemical tests or reactions on the substrate. The ink jet device, the method for controlled positioning of droplets of a substance and the use of an ink jet device according to the present invention are preferably applied to the printing process of substances onto a substrate, where it is extremely hazardous if a substance of a certain kind is applied wrongly onto a certain region of the substrate, such as is the case in diagnostics.

The diagnostics of infectious diseases demands for a very high reliability of the overall process of making the substrate provided with the different capture probes, and more specifically the printing process of the capture probes. The read-out of the assay substrate for instance relates diseases directly to the positions of the specific capture probes. It is therefore important to be able to position the capture probes on the membrane reliably and correctly. During the whole process of producing the assay substrate, it would be highly desirable to be able to record which capture fluid is being processed. At the very moment some information is lost, the quality of the membrane, which eventually selects the DNA of the different infectious diseases, cannot be guaranteed anymore.

### SUMMARY OF THE INVENTION

It is therefore an object of the present invention to provide an ink jet device and method for producing a biological assay substrate by depositing a plurality of substances onto the substrate, which device and method allow to produce the substrate in a reliable manner.

The above objective is accomplished by an ink jet device for producing a biological assay substrate by depositing a plurality of substances onto a substrate, as described in claim 1, by a method for producing such assay substrate, and by the use of an ink jet device according to the present invention. The ink jet device according to the invention comprises at least a print head and a plurality of substance containers connectable thereto, and mounting means for the containers, whereby at least part of the containers is provided with identification means and the ink jet device further comprises reading means to read information contained in the identification means.

It is an advantage of the ink jet device according to the present invention that it becomes possible to know about exactly which substance is present inside the print head at a particular moment in time, and to know how much of this substance lands on which position. A typical processing sequence involves the following. At the site of the capture or probe molecules manufacturer, the molecules are synthesized and put into containers and stored. The capture molecules are then dissolved in a suitable solvent, known per se, to make them solution processable by ink-jet printing or by other dispensing techniques. The solutions may be produced at the site of the probe molecules manufacturer, or they may be produced at the site of the substrate manufacturer, i.e. the site where the capture molecules are deposited onto the surface, which obviously necessitates previous transportation and storage of the probe molecules to this site. The produced solutions are stored again until they are transferred to suitable printing or dispensing containers. When the actual substrate has to be produced, the printing or dispensing containers are mounted on the ink jet printer or other suitable dispensing device to print or dispense the solution on predefined positions on the substrate. After placing all spots the substrates are transferred to another station where the capture or probe molecules are bound to the substrate surface, for instance by UV-exposure, and the unbound material is then washed away and the unbound surface blocked. After this washing/blocking step, the substrates are typically dried under inert conditions. Finally the substrates are packed, stored, transported, stored again and unpacked for use in a bio sensor set-up to check for infectious diseases of a patient.

According to the invention, the containers with a particular substance can be constantly monitored during their processing since they are provided with identification means. By further providing reading means, which can read the information embodied in the identification means, it not only becomes possible to identify each container as such, but also to decide whether a particular container is in the right position on the ink jet device. Indeed the read information (‘ist’) can in general terms be compared to the desired information (‘soll’), on the basis of which comparison a particular container can be rejected or accepted.

To avoid errors, it is preferred according to the invention to provide the containers with identification means, such as a suitable coding, as close as possible to the moment the capture or probe molecules are made and dissolved. As indicated above this may for instance be carried out at the site of the probe molecules manufacturer, although this is not necessary.

According to a preferred embodiment of the ink jet device according to the invention, the identification means on the containers comprise a barcode. Barcodes are readily applied onto the containers, and moreover can be easily read by a suitable bar code reader. The advantage of this embodiment is that the container may be identified, and for instance its content determined, at any time during processing thereof. For instance it becomes possible to read a particular container prior to shipping from the probe molecule manufacturer to the site of the substrate producer, or, at the site of the latter, to read the container when transferring it from a warehouse to the printing area, where actual substrate production is taking place. Another, even more preferred embodiment of the ink jet device according to the invention uses containers having identification means that comprise a coded read-only chip. Such chips are known per se, for instance those having contacts at the outside, as used in a bank or identification card.

According to a particularly preferred ink jet device according to the invention, the identification means on the containers comprise a coded RF-ID chip. Such chips are known per se, for instance as a resonance label in anti-theft systems. A coded RF-ID chip can be read or interrogated by a suitable wireless RF reader over some distance. This allows to locate the presence of particular containers from a central position in a warehouse for instance. Such a reader is typically provided with a transmitting antenna, able to communicate through radio frequency waves with the RF-ID chip. An energetic signal of any kind is emitted by the transmitting antenna to the RF-ID chip, which signal is subsequently ‘processed’ by the chip, and thereafter in modified form re-emitted to a receiver with receiving antenna, also incorporated in the reader. The chip is thus subjected to an inquiry by the transmitting antenna and emits, depending on the specific circumstances wherein the container finds itself, a response signal to the receiver. By adapting the emitting frequencies, the range over which such chips may be read can be modified, for instance extended to larger distances.

The above described embodiments provide an ink jet device that allows to readily identify any container, and determine for instance its content and its position at any time. In a particularly preferred embodiment, the ink jet device reads out the location of at least part of the containers and couples this directly to the printing or depositing plan. In this way, the order of the solutions to be processed may be determined automatically. In other words, the ink jet device according to this embodiment configures itself according to the detected content of the containers.

In another preferred embodiment of the ink jet device according to the invention, the identification means comprise a hardware key with electronic contact means and/or with mechanical interlocking means. This preferred embodiment has the additional advantage of providing the possibility to accept or reject certain containers by providing a hardware key reader. In one preferred embodiment the electronic contact means of the hardware key comprise a specific pattern of electronic contacts, which are readable by the hardware key reader, which reader comprises a plurality of counter electrodes. In another preferred embodiment, the mechanical interlocking means of the hardware key comprise a plurality of protrusions (depressions) with specific shape, which are readable by the hardware key reader, which reader comprises a plurality of counter depressions (protrusions), shaped such that they can accept the protrusions (can be accepted by the depressions). Embodiments with identification means in the form of a hardware key are particularly preferred when providing the hardware key or hardware key reader onto the ink jet printer itself. In such embodiment the containers are then provided with a corresponding hardware key reader, respectively hardware key. The use of a hardware key has the additional advantage that actual positioning of the containers onto the printing device can be combined with identification, and possible acceptance or rejection, of the containers. Moreover the use of such hardware key allows to check the exact positioning of the containers in the printing device, when several hardware keys are used dependent on position and content of the containers for instance.

In another preferred embodiment, the ink jet device further comprises a stage with fixture plate, provided with mounting means for the containers. The mounting means may be any structure, able to retain the containers in a particular position, such as for instance holes that can receive at least part of the containers. A particularly preferred ink jet device comprises a print table and a printing bridge, wherein the stage with fixture plate is movable relative to the print table along a first direction, wherein the print head is mounted on a movable print head holder being mounted to the printing bridge such that the print head is movable relative to the printing bridge along a second direction. Thereby it is possible to print or deposit droplets of a substance to a large area of application such that the production of printed products can be made quite cost effective because large substrates or individual substrates can be printed as one batch.

A further preferred embodiment the ink jet device comprises mounting means for the containers provided with the reading means. By providing the mounting means with reading means, such as a hardware key reader, positioning of the containers onto the printing device is combined with identifying the containers. When the containers are provided with hardware keys for instance (much like house door keys), mounting means for the containers in the form of holes actually perform like keyholes. The holes may for instance be provided with interlocking means, which lock the containers into position upon imposing on them a particular movement, such as a pressing or turning movement. By providing the possibility to apply the movement for a particular container only at the right position, the possibility for accepting or rejecting a particular container is provided. For instance, if one attempts to provide a hole with the wrong container, the container may not be interlocked with the hole, for instance because it can not be turned, which leaves the top end of the container above the printing or dispensing surface, thereby preventing printing or dispensing. A correctly positioned container on the other hand may be turned and pushed into its corresponding hole, thus allowing normal printing or dispensing operation. Preferably, each mounting position or hole is provided with reading means in the form of a barcode or coded read-only (RF-ID) chip reader. In that way the printing or dispensing device can check whether it is taking substance out of the correct container. This improves the reliability of the printing or dispensing process considerably.

It has advantages to characterize the ink jet device according to the invention in that the print head thereof is provided with the reading means. The reading means, preferably in the form of RF-readout means is attached to the print head, whereby preferably the communication range is selected such that the corresponding RF-ID chip is only read-out when the print head is in the direct vicinity of the container. To further improve the identification operation, the communication range is selected such that adjacent containers are preferably not readable. This particular embodiment has the additional advantage that it performs a check whether the printer (software) program directs the print head to the correct position to fill the dispensing unit. If the dispensing unit is not going to the correct position for filling, the wrong RF-ID chip will be read-out and the printing process may come to a halt and gives a warning.

Another particularly preferred embodiment of the ink jet device according to the invention further comprises means to provide the substrate with an identification. During a typical printing process, a plurality of say 10-100 different substances are typically deposited on the substrate, although their number may be substantially higher. Due to the identification means on the containers, it is exactly known which substances are present in particular containers. In the present embodiment at least one of the substances comprises a fluorescent fluid that may be printed on the substrate, preferably on the sides of it. Particularly preferred is to print each batch with a different identification mark, for instance binary code, but preferably an identification code that comprises a series of spots on the substrate allocated for a batch number, and another series of spots that will be different for each substrate.

In a further preferred embodiment, a database is provided in which all properties of each batch are stored. The properties that can be thought of are general processing parameters like batch number, date and time of processing, name of the operator, temperature, and so on. During the printing process, images are preferably recorded of each substance drop landed on the substrate, as well as acoustic spectra of the print head. These data are stored in the database for future reference. The printing process may then be discontinued if either the optical data or the acoustical data are not within the pre-determined processing window. In case a non-functioning sample is found later on, for instance during quality control or during detection, it now becomes possible to retrace whether the findings can be related to the results as stored in the database.

Although the ink jet device according to the invention may be provided with a print head with one nozzle only, the ink jet device preferably comprises a plurality of single nozzle print heads and/or a multi nozzle print head and/or a plurality of multi-nozzle print heads. Thereby, it is possible to eject a plurality of droplets out of one single print head. This speeds up the printing process.

According to the present invention, it is preferred that the substrate is a flat substrate, a structured substrate or a porous substrate. More preferably, the substrate is a nylon membrane, nitrocellulose, or PVDF substrate, or a coated porous substrate. Because the substrate is preferably porous, the spots or the droplets do not only lie on the surface, but also penetrate into the membrane.

In a still further embodiment of the present invention, the substrate comprises a plurality of substrate areas, each substrate area preferably being a separated membrane held by a membrane holder. Thereby, a plurality of separated membranes is possible to produce by the use of the inventive ink jet device.

Further preferably, the substrate comprises a plurality of substrate locations, the substrate locations being separated from each other at least the average diameter of a droplet positioned at one of the substrate locations. Thereby, it is possible to precisely and independently locate different droplets of a substance at precise locations on the substrate. It is also possible and advantageous to place a plurality of droplets on one and the same substrate location.

The substance, comprising biologically active molecules, is preferably dissolved in a solution. This solution is typically a liquid, like water or different types of alcohol, and may also contain small amounts of additives, for instance to adjust the surface tension, viscosity or boiling point, in order to optimize print characteristics, spot formation, shelf life of the biofluids, and so on.

The present invention also includes a method for producing a biological assay substrate by releasing a plurality of substances from containers onto the substrate using an ink jet device, whereby at least part of the containers is provided with identification means, and whereby the information contained therein is read by reading means. As already described above in more detail the method preferably uses identification means comprising a barcode, whereby the information is read by a barcode reader. Other preferred embodiments of the method use identification means comprising a coded read-only chip, whereby the information is read by a chip card reader, and preferably a RF-ID chip, whereby the information is read by a wireless RF reader.

By adopting the method of the invention, it becomes possible to trace a particular container essentially in a continuous manner during its different processing steps. It thus becomes possible to verify whether a particular container has the right content, and is positioned in the right position during the printing process. When out of bound, defective, or misidentified, the printing process may be discontinued and the particular container removed from the process. The present invention may thus provide for a higher degree of accuracy and reliability of the printing process and may further provide retraceable data after the occurrence of some malfunction.

A particularly preferred method identifies the containers by a hardware key with electronic contact means provided on the containers, whereby the information is read by a hardware key reader, which reader comprises a plurality of counter electrodes. Another preferred variant of the invention uses a hardware key with mechanical interlocking means, whereby the information is read by a hardware key reader, which reader comprises corresponding mechanical interlocking means.

Although the reading means to read the information contained in the identification means provided on the containers may be stand alone reading apparatus, a particularly preferred method reads the information by reading means, provided on the ink jet device. A particularly preferred method includes mounting the containers onto the ink jet device by inserting them in mounting means for the containers, such as holes, provided on a stage with fixture plate. It is preferred in this method to read the information by reading means, provided on the mounting means. This embodiment of the method does not only allow to identify the container and its content as such, but also allows to determine whether a particular container is actually in the correct position or not. In this way the reliability and accuracy of the printing process is further improved.

Another preferred method reads the information provided by the identification means onto the containers by using reading means provided on the print head. This embodiment of the method allows to verify whether the print head is actually moving to the correct position, for instance to fill the dispenser.

The present invention also includes the use of an inventive ink jet device according to the present invention, wherein the substance comprises a biochemical reactant and/or a nucleic acid, and/or an oligonucleotide, and/or a polypeptide and/or a protein, and/or a cell, and/or (parts of) RNA/PNA/LNA. By using the inventive ink jet device for such a purpose, it is possible to very accurately print a certain number of substances on a substrate without an error to which substance is printed.

The present invention also relates to an assay substrate comprising a plurality of substances for biological analysis, which substrate may be obtained by the ink jet device and method of the present invention.

### BRIEF DESCRIPTION OF THE DRAWINGS

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

In the figures

FIG. 1 illustrates schematically a top view of an embodiment of the ink jet device of the present invention;

FIG. 2 illustrates schematically a cross section through a substrate area and a membrane holder;

FIG. 3 illustrates schematically a print head with a nozzle and reading means;

FIG. 4 illustrates schematically a top view of another embodiment of the ink jet device of the present invention.

### DETAILED DESCRIPTION OF THE EMBODIMENT

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the present description and claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

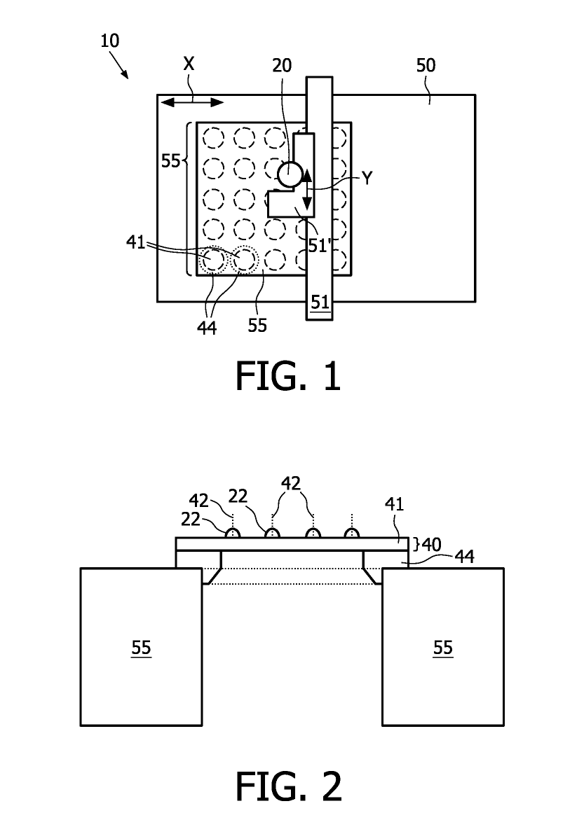

In FIG. 1, a schematic top view of the ink jet device 10 according to the present invention is shown. On a print table 50a fixture plate 55 is mounted on a linear stage allowing for motions in the X-direction of the fixture plate 55. In this fixture plate 55, a number of substrate holders 44 with substrates or membranes 41 are positioned. The substrate holder 44 may have any form but is basically only a ring 44. A round membrane 41 is welded onto this ring. So, after printing, the ring 44 with spotted membrane 41 together constitutes the final product. A printing bridge 51 is rigidly mounted relative to the print table 50. The printing bridge 51 carries the movable print head holder 51′. The stage with the fixture plate 55 is moveable along a first direction, the X-direction. A print head 20 is mounted to the movable print head holder 51′ such that it is moveable along a second direction, the Y-direction, relative to the printing bridge 51. Thereby, the print head 20 can be positioned over a certain area of a print table 50 and can release droplets of a substance, which is stored in the print head 20 or in a container 60 (see FIG. 4) within reaching distance of the print head 20. The membranes 41 are mounted in the fixture plate 55, also called registration plate 55 at preferably uniform distance in X-direction and uniform distance in Y-direction. The distance in X-direction may differ from the distance in Y-direction.

Substrates 41 may be made of a bio active membrane used for the detection of infectious diseases. Diagnostics of such diseases demands for a very high reliability of the printing process. The read out of the fluorescent pattern relates diseases directly to the positions of the specific capture probes. Therefore, it is absolutely necessary to have a very reliable process for the printing of the correct substance out of a plurality of different substances.

In FIG. 2, a schematic representation of a cross sectional view of an individual substrate or membrane holder 44 and a part of the fixture plate 55 is shown. The substrate holder 44 carries one membrane 41. Each individual substrate holder 44 is located on the fixture plate 55 fixedly mounted on a linear stage allowing for a linear motion in the X-direction relative to the granite table (print table) 50. On each substrate 41, a plurality of substrate locations 42 are provided such that an individual dot (schematically shown by reference sign 22 in FIG. 2) is able to be located at a distance from one another. A dot can be formed out of one droplet dispensed by the print head or is built-up out of a plurality of droplets of the same substance. Thereby, it is possible to dispense or to position a different kind of substance on each of the substrate locations 42.

In FIG. 4 a detail is shown of a fixture or registration plate 55. The substrates 41 to be printed are mounted onto plate 55. Also the containers 60 with the different capture or probe molecule solutions are mounted on fixture plate 55 through suitable mounting means in the form of holes (not shown in detail). Additional containers 61 with cleaning fluids and a container 62 for waste may also be mounted on plate 55, as shown in the figure. According to an embodiment of the method of the invention, the capture molecules are dissolved in the appropriate solvents to produce the substances 23, at the site of the manufacturer of the capture molecules or at the site where the solutions will be printed, and put into small containers 60 and immediately marked with identification means 63 in the form of a barcode, a coded read only (RF-ID) chip and/or a hardware key. For a specific fluid 23 the set of containers 60 to be filled with that fluid 23 has either a hardware key with electronic contacts or a mechanical structure like for instance a house door key, or it has wireless read out means in the form of small RF antennas.

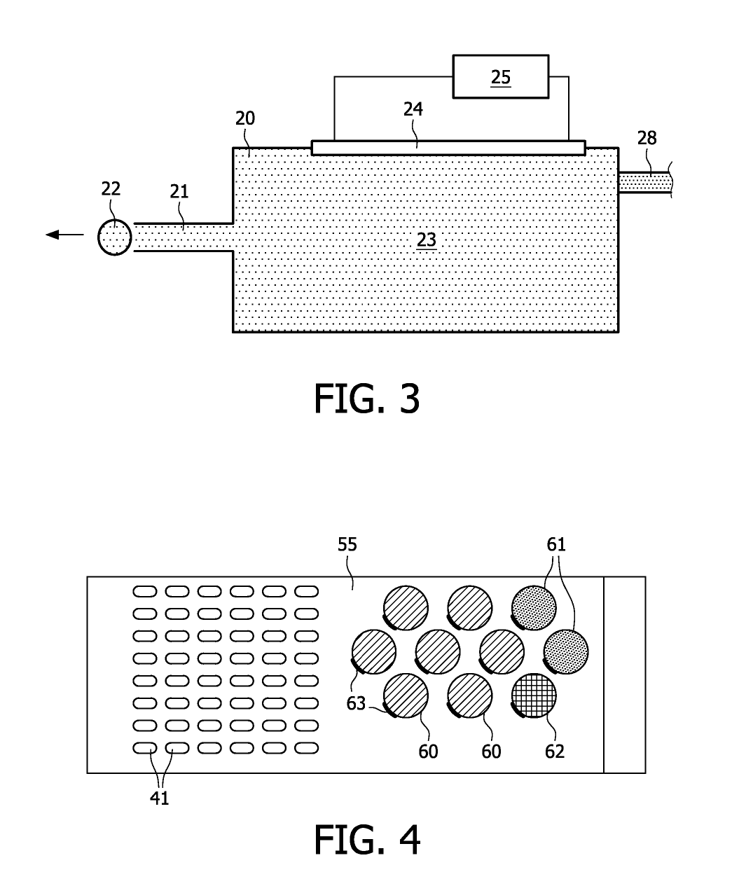

Before the printing process starts, containers 60 are positioned on the registration plate 55. According to one embodiment of the invention, the printing or dispensing device 10 is provided with a barcode reader 25 (see for instance FIG. 3 for an embodiment where the reader is located onto the print head 20) to detect the content 23 of particular containers 60 marked with a barcode 63. For containers 60 provided with a coded read-only chip 63 the printer or dispenser 10 is alternatively provided with a read-out unit (either via electrical contacts or though radio frequency RF) to read the content of the chip 63 and in that way the code of the content of the container 60. Of course, if desired it is also possible to provide identification means and corresponding reading means to determine the content of other containers present, such as containers 61 and 62 for instance. In case the containers 60 are provided with a hardware key with electronic contacts the holes in the registration plate 55 may detect the specific combinations of contacts and in that way the code of the content of the container 60. In another embodiment of the invention the containers 60 are provided with hardware keys much like house door keys. The holes for the containers 60 then act much like keyholes. It is particularly preferred to provide the holes with mechanical interlocking means, comprising a plurality of protrusions with specific shape, which are readable by the hardware key reader, which reader comprises a plurality of counter depressions, for instance arranged in the sidewall of the hole and shaped such that they can accept the protrusions. A particular container may then only access a correct hole for it, i.e. a hole with the right combination of depressions for the particular set of protrusions, present on the container. After entering such hole, the container may then be locked into place, for instance by an angular turn, which turn is only possible in the right position. After the turn the positioning of the container 60 below the print or dispense surface can be reached. In other case printing or dispensing is not possible, because the top end of the container is too high for printing or dispensing. As already mentioned above, by providing a suitable amount of holes, for instance each hole with a barcode or coded read-only (RF-ID) chip, the printer or dispenser 10 can check whether it is taking fluid 23 out of the right container 60.

In another embodiment of the invention the readout means, preferably RF, is attached to the print head 20. In FIG. 3, a print head 20 with a nozzle 21 and reading means 25 is schematically shown. The print head 20 also comprises a transducer 24, preferably a piezoelectric transducer 24. Generally, an electromechanical transducer 24 being able to provide mechanical waves inside the print head 20 can be used as a transducer 24. The transducer 24 can be actuated by an activation pulse (not shown) provided by a control unit (not shown). Print head 20 is provided with a further duct or throttle 28. Such a throttle is preferably used in order to obtain sufficient damping when processing low viscosity fluids. There are typically two ways of filling the print head with substance 23 from container 60, either by aspiration through the nozzle directly out of container 60 by means of a vacuum pump (not shown), or alternatively by filling through a tube that connects the throttle with container 60. In order to ensure proper action at the meniscus in the nozzle an under-pressure of a few cm's water column is usually applied. According to the present invention the reading means 25 are able to communicate with identification means 63, provided on containers 60 and/or on suitable mounting means, for instance in the form of holes in plate 55. To print the substance 23 transducer 24 is actuated by an actuation pulse such that a droplet 22 is ejected from the nozzle 21 of the print head 20. The communication range of the reader should preferably be such that the RF-ID chip present on a container 60 and/or a hole is only read out when the print head is very close to the container and/or hole (no adjacent containers should preferably be readable). This embodiment has the advantage of providing an additional check as to whether the printer program (software) is directing the print head 20 to the correct container 60 position, for instance to fill the dispensing unit 23 of print head 20. If the dispensing unit 23 is not directed to the correct position for filling, the wrong RF-ID chip will be read out, and an incorrect reading message produced. Subsequently the printing process may be interrupted and a warning may be given. However, according to a preferred embodiment, it would also be useful to scan all the bottles in one run before a print run starts, and subsequently compose the print plan automatically, or give a warning in case an incorrect container is used. In this way indeed, all the bottles are scanned just prior to filling the print head with the fluids inside.

When carrying out the method according to the invention, it is particularly preferred to perform coding of the containers as close as possible to the moment the capture or probe molecules are made and dissolved. In this way, it is exactly known that the correct fluids 23 are placed on known positions on the registration plate 55.

In case throwaway print heads and containers are used, they may typically be used only once and discarded after use. In case expensive printing or dispensing devices and containers are used, the devices or containers are typically cleaned after use and sent back to the capture molecule manufacturer for refill and recoding. Recoding is not possible for hardware key systems. In this variant of the method, the same key code has to be used on the refilled containers to ensure that the right fluid comes into the right device. The final cleaning step is typically performed as close as possible prior to filling and may preferentially be performed at the site where the printing process takes place.

Another preferred method comprises performing the handling with the capture (probe) molecules at one and the same department at the site where the printing process takes place. It is even more preferred to combine all different method steps to one particular site, which is for instance a hospital laboratory. This laboratory then handles the different capture (probe) substances, carries out the process of printing or dispensing substances on the membranes and/or substrates and performs the clinical tests.

By continuously monitoring the printing process and in particular the identification of the containers and their content, a substrate may be produced accurately and reliably, minimizing the occurrence or even avoiding misprints as much as possible. In case a plurality of different substances are continually printed on a series of substrates the device and method yields information about the course of the whole production process of the biological assay substrates. In case one or more containers are incorrectly filled and/or positioned and/or reading their identification entails problems of some kind, immediate action may be undertaken. For instance, the printing process may be stopped and the erroneous containers removed, or it may be impossible even to mount the containers on the printing device altogether, which is for instance the case for an embodiment involving hardware keys. Use of the method and inkjet device according to the invention prevents misprinting of substrates and therefore obviates the need of previous methods to mark incorrectly printed substrates during the printing process and remove these out of the batch after the whole print process is ready. It is also possible to stop the printing process and reshuffle the containers until they are in the correct position. Obviously several other possible remedies may be envisaged by the person skilled in the art.

1. Ink jet device (10) for producing a biological assay substrate (40) by releasing a plurality of substances (23, 23a, 23b) onto the substrate (40), the device (10) comprising at least a print head (20) and a plurality of substance containers connectable thereto, and mounting means for the containers, whereby at least part of the containers is provided with identification means (25) and the device further comprises reading means to read information contained in the identification means.

2. Ink jet device (10) according to claim 1, wherein the identification means comprise a barcode.

3. Ink jet device (10) according to claim 1, wherein the identification means comprise a coded read-only chip.

4. Ink jet device (10) according to claim 3, wherein the coded read-only chip comprise a RF-ID chip.

5. Ink jet device (10) according to claim 1, wherein the identification means comprise a hardware key with electronic contact means and/or with mechanical interlocking means.

6. Ink jet device (10) according to claim 1, wherein the reading means are selected from a barcode reader, a chip card reader, and/or a hardware key reader.

7. Ink jet device (10) according to claim 6, wherein the electronic contact means of the hardware key comprise a specific pattern of electronic contacts, which are readable by the hardware key reader, which reader comprises a plurality of counter electrodes.

8. Ink jet device (10) according to claim 6, wherein the mechanical interlocking means of the hardware key comprise a plurality of protrusions (depressions) with specific shape, which are readable by the hardware key reader, which reader comprises a plurality of counter depressions (protrusions), shaped such that they can accept the protrusions (can be accepted by the depressions).

9. Ink jet device (10) according to claim 1, wherein the ink jet device (10) further comprises a stage with fixture plate (55), provided with mounting means for the containers, such as holes.

10. Ink jet device (10) according to claim 9, wherein the ink jet device (10) further comprises a print table (50) and a printing bridge (51), wherein the stage with fixture plate (55) is movable relative to the print table (50) along a first direction (X-direction), wherein the print head (20) is mounted on a movable print head holder being mounted to the printing bridge (51) such that the print head (20) is movable relative to the printing bridge (51) along a second direction (Y-direction).

11. Ink jet device (10) according to claim 1, wherein the mounting means are provided with the reading means.

12. Ink jet device (10) according to claim 1, wherein the print head is provided with the reading means.

13. Ink jet device (10) according to claim 1, wherein the ink jet device (10) further comprises means to provide the substrate (41) with an identification.

14. Ink jet device (10) according to claim 13, wherein the means to provide the substrate (41) with an identification comprise a printed code.

15. Method for producing a biological assay substrate (41) by releasing a plurality of substances (23, 23a, 23b) from containers onto the substrate (41) using an ink jet device (10), whereby at least part of the containers is provided with identification means (25), and whereby the information contained therein is read by reading means.

16. Method according to claim 15, wherein the identification means comprise a barcode, and the information is read by a barcode reader.

17. Method according to claim 15, wherein the identification means comprise a coded read-only chip, and the information is read by a chip card reader.

18. Method according to claim 17, wherein the coded read-only chip comprise a RF-ID chip, and the information is read by a wireless RF reader.

19. Method according to claim 15, wherein the identification means comprise a hardware key with electronic contact means, and the information is read by a hardware key reader, which reader comprises a plurality of counter electrodes.

20. Method according to claim 15, wherein the identification means comprise a hardware key with mechanical interlocking means, and the information is read by a hardware key reader, which reader comprises corresponding mechanical interlocking means.

21-30. (canceled)
